(19) United States
(12) Patent Application Publication
(10) Pub. No.: US 2025/0078600 A1
(43) Pub. Date: Mar. 6, 2025

(54) MONEY HANDLING APPARATUS, MONEY HANDLING SYSTEM, AND MANUFACTURING METHOD FOR MANUFACTURING MONEY HANDLING APPARATUS

(71) Applicant: GLORY LTD., Hyogo (JP)

(72) Inventors: Yusaku TACHIBANA, Hyogo (JP); Sota OKADO, Hyogo (JP)

(21) Appl. No.: 18/953,148

(22) Filed: Nov. 20, 2024

Related U.S. Application Data
(63) Continuation of application No. PCT/JP2023/016434, filed on Apr. 26, 2023.

(30) Foreign Application Priority Data
May 25, 2022 (JP) 2022-085214

(51) Int. Cl. G07D 11/125; E05G 1/10; G07D 11/40

(52) U.S. Cl. CPC G07D 11/125; E05G 1/10; G07D 11/40

(57) ABSTRACT

The money handling apparatus comprises a safe for storing money, a conveyor that performs at least one of transporting the money to the safe and transporting the money from the safe, at least one sensor that detects the state of the safe, and a circuit board that acquires a detection signal from the sensor, transmits information based on the acquired detection signal to a first computer, and transmits at least part of the information to a second computer.

### CROSS REFERENCE TO RELATED APPLICATIONS

This application is a bypass continuation of International Patent Cooperation Treaty Application No. PCT/JP2023/016434, filed on Apr. 26, 2023, which claims priority to Japanese Patent Application No. 2022-085214, filed on May 25, 2022, the entire disclosures of each are incorporated herein by reference.

### TECHNICAL FIELD

The present disclosure relates to a money handling apparatus, a money handling system, and a manufacturing method for manufacturing a money handling apparatus.

### BACKGROUND ART

Conventionally, money handling apparatuses that store money in a safe have been used. Such money handling apparatuses are equipped with a sensor that detects the state of the safe, for example, a sensor that detects whether the money safe door is closed.

### SUMMARY

A money handling apparatus according to the present disclosure comprises: a safe for storing money; a conveyor that performs at least one of transporting the money to the safe and transporting the money from the safe; at least one sensor that detects a state of the safe; and a circuit board that acquires a detection signal from the sensor, transmits information based on the acquired detection signal to a first computer, and transmits at least part of the information to a second computer.

### BRIEF DESCRIPTION OF DRAWINGS

FIG. 1 is a block diagram of a money handling apparatus and a money handling system according to Embodiment 1;

FIG. 2 is a block diagram of the money handling apparatus and money handling system according to Embodiment 2;

FIG. 3 is a block diagram of the money handling apparatus and money handling system according to Embodiment 3;

FIG. 4 is a block diagram of the money handling apparatus and money handling system according to Embodiment 4;

FIG. 5 is a block diagram of the money handling apparatus and money handling system according to Embodiment 5;

FIG. 6 is a block diagram of the money handling apparatus and money handling system according to Embodiment 6;

FIG. 7 is a block diagram of the money handling apparatus and money handling system according to Embodiment 7; and

FIG. 8 is a flowchart of a manufacturing method for manufacturing the money handling apparatus.

### DESCRIPTION OF EMBODIMENTS

The sensor that detects the state of the safe is installed by the operator of the money handling apparatus. Then, detection information from the sensor is sent directly from the sensors to a computer used by the operator, without going through a control apparatus that the money handling apparatus comprises.

Therefore, there is a possibility that the maintenance operator may not be able to detect anomalies such as faults that occur in the sensor.

The present disclosure aims to enable maintenance operators to detect anomalies that occur in a sensor that detects the state of the safe that a money handling apparatus comprises.

A money handling apparatus according to the present disclosure comprises: a safe for storing money; a conveyor that performs at least one of transporting the money to the safe and transporting the money from the safe; at least one sensor that detects a state of the safe; and a circuit board that acquires a detection signal from the sensor, transmits information based on the acquired detection signal to a first computer, and transmits at least part of the information to a second computer.

In the money handling apparatus according to the present disclosure, the circuit board may be disposed inside the safe.

The money handling apparatus according to the present disclosure may further comprise a case that houses the circuit board in a covered state.

The money handling apparatus according to the present disclosure may further comprise a case sensor that transmits a detection signal regarding an opening and closing state of the case to the circuit board. In addition, the circuit board may be configured to transmit the detection signal regarding the opening and closing state to at least one of the first computer and the second computer upon acquiring the detection signal regarding the opening and closing state.

The money handling apparatus according to the present disclosure may further comprise a first power supply apparatus configured to be capable of supplying power to the conveyor and the circuit board, and a second power supply apparatus configured to be incapable of supplying power to the conveyor but capable of supplying power to the circuit board, and a switching apparatus that, when supplied with power from the first power supply apparatus, supplies the power supplied from the first power supply apparatus to the circuit board, and when not supplied with power from the first power supply apparatus, supplies the power supplied from the second power supply apparatus to the circuit board.

The sensors that the money handling apparatus according to the present disclosure comprises may be a sensor that detects at least one of opening and closing of a door of the safe, a vibration of the safe, a temperature of the safe, and a condition of a fixing member that fixes the money handling apparatus to a fixation portion.

A money handling system according to the present disclosure comprises a money handling apparatus connected to a first computer; and a second computer connected to the money handling apparatus, in which the money handling apparatus comprise: a safe for storing money; a conveyor that performs at least one of transporting the money to the safe and transporting the money from the safe; at least one sensor that detects a state of the safe; and a circuit board that acquires a detection signal from the sensor, transmits information based on the acquired detection signal to the first computer, and transmits at least part of the information to the second computer, and the second computer monitors the money handling apparatus based on the at least part of the information.

In the money handling system according to the present disclosure, the second computer may be disposed inside the money handling apparatus.

In the money handling system according to the present disclosure, the second computer may be disposed inside the safe.

In the money handling system according to the present disclosure, the circuit board may be disposed inside the safe. The second computer may be disposed adjacent to the circuit board. The second computer may be integrated with the circuit board.

In the money handling system according to the present disclosure, the second computer may be disposed outside the money handling apparatus and may be communicably connected to the money handling apparatus.

In the money handling system according to the present disclosure, the circuit board may transmit the information to the first computer and simultaneously transmit the at least part of the information to the second computer.

In the money handling system according to the present disclosure, the circuit board may temporarily hold the at least part of the information and transmit the at least part of the information to the second computer in case that a communication session between the second computer and the money handling apparatus is established.

In the money handling system according to the present disclosure, the first computer may monitor the money handling apparatus based on the information.

In the money handling system according to the present disclosure, in case that the second computer determines, based on the at least part of the information, that an anomaly occurs in the money handling apparatus, the second computer may transmit, to the first computer, notification information indicating the occurrence of the anomaly in the money handling apparatus.

In addition, a manufacturing method for manufacturing a money handling apparatus according to the present disclosure comprises: selecting one kit from a group of kits that include a plurality of kits with configurations different from one another; assembling a money handling apparatus that comprises a safe and a conveyor that performs at least one of transporting money to the safe and transporting the money from the safe; and attaching the selected kit to the money handling apparatus, in which each kit of the plurality of kits includes a sensor that differs from one another among the plurality of kits and a circuit board of a type that is common to the plurality of kits.

According to the present disclosure, a maintenance operator can detect anomalies that occur in a sensor for detecting the state of the safe that a money handling apparatus comprises.

### Embodiment 1

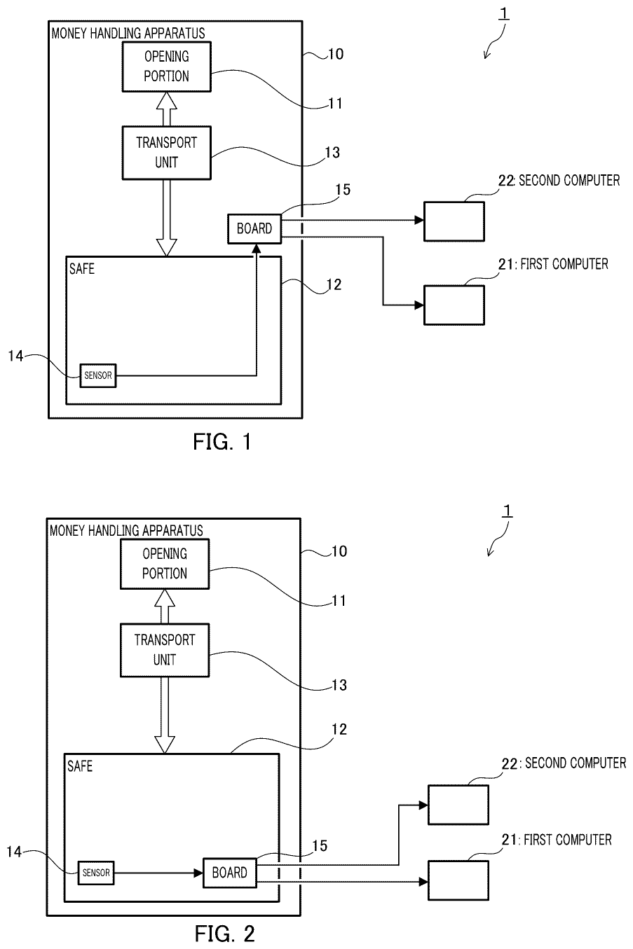

FIG. 1 is a block diagram of a money handling apparatus 10 and a money handling system 1 according to Embodiment 1 of the present disclosure. The money handling system 1 comprises the money handling apparatus 10 communicably connected to a first computer 21 and a second computer 22. The money handling system 1 may comprise the first computer 21.

The money handling apparatus 10 is installed in facilities such as banks and other financial institutions, retail stores such as convenience stores, or security transport agencies, and is an apparatus that handles money. Specific examples thereof include banknote and coin deposit machines, banknote and coin withdrawal machines, banknote and coin deposit and withdrawal machines, cash dispensers, tax and public money payment machines, money exchange machines, cash registers, ticket vending machines, vending machines, money change machines, proceeds-from-sales deposit and withdrawal machines, banknote counters, banknote sorters, banknote bundling machines, electronic money charging machines, and banknote disinfection apparatuses.

The money handling apparatus 10 comprises an opening portion 11, a safe 12, a conveyor 13, a sensor 14, and a circuit board 15.

When the money handling apparatus 10 is capable of deposit processing, the opening portion 11 is a deposit unit or a deposit/withdrawal unit. When the money handling apparatus 10 is capable of withdrawal processing, the opening portion 11 is a withdrawal unit or the deposit/withdrawal unit. The opening portion 11 may be a combination of the deposit unit and the withdrawal unit. The opening portion 11 includes an opening formed in a housing that forms the outer surface of the money handling apparatus 10.

The safe 12 is a box-shaped apparatus in which money is stored. The money stored in the safe 12 cannot be accessed from outside the safe. A storage unit may be disposed inside the safe 12, and money may be stored in the storage unit or directly in the safe 12 itself. The safe 12 may comprise a lockable door. This door is unlocked and opened when removing money stored inside the safe 12 or when storing money inside the safe 12 without using the conveyor 13. The safe 12 may be disposed inside the housing of the money handling apparatus 10 or may form a part of the housing of the money handling apparatus 10.

The conveyor 13 is comprised of transport apparatuses such as conveyors and rollers. The conveyor 13 performs at least one of transporting money to the safe 12 and transporting money from the safe 12. When the opening portion 11 is the deposit unit or the deposit/withdrawal unit, the conveyor 13 transports money from the opening portion 11 to the safe 12. When the opening portion 11 is the withdrawal unit or the deposit/withdrawal unit, the conveyor 13 transports money from the safe 12 to the opening portion 11. The white arrows in FIG. 1 indicate the flow of money. The conveyor is disposed inside the housing of the money handling apparatus 10. In addition, the money handling apparatus 10 may comprise a recognition unit that recognizes the denomination, fitness, and the like of the money. The recognition unit may be provided in the conveyor 13 so as to capable of recognizing the money being transported by the conveyor 13.

The sensor 14 detects the state of the safe 12. The sensor 14, for example, detects at least one of the opening and closing of the door of safe 12, the vibration of safe 12, the temperature of safe 12, and the condition of a fixing member that fixes the money handling apparatus 10 to a fixation portion. The fixation portion is, for example, the floor, and the fixing member is, for example, a stud bolt embedded in the floor and a nut attached to this stud bolt. The condition of the fixing member changes when the stud bolt is pulled out of the floor or the nut is removed from the stud bolt. The sensor 14 may detect this change in condition. As the sensor 14, a sensor depending on the purpose can be installed. The sensor 14 may be a sensor that can detect elements other than the opening and closing of the door of safe 12, the vibration of safe 12, the temperature of safe 12, and the condition of the fixing member that fixes the money handling apparatus 10 to the fixation portion.

The sensor 14 may be disposed inside or outside of safe 12.

Although only one sensor 14 is shown in FIG. 1, the money handling apparatus 10 may comprise a plurality of sensors 14. In that case, the sensors 14 may be sensors 14 differing in type from one another. For example, one of the plurality of sensors 14 may detect the opening and closing of the door of safe 12, and another may detect the vibration of safe 12. Also, each sensor 14 may be of the same type but attached in different positions. For example, a plurality of sensors 14 may be temperature sensors, with one of the sensors 14 attached to one side of safe 12 and another attached to another side of safe 12. In this case, one of the plurality of sensors 14 detects the temperature of one side of safe 12, and another detects the temperature of another side.

The circuit board 15 is an electronic board that acquires a detection signal from the sensor 14 and processes the acquired detection signal electrically or electronically. In the present embodiment, the circuit board 15 is disposed inside the money handling apparatus 10 and outside the safe 12. The solid arrows in FIG. 1 indicate the flow of signals or information.

The circuit board 15 comprises a CPU, memory, and connectors. The circuit board 15 may comprise the sensor 14. In other words, the sensor 14 may be mounted on the circuit board 15. For example, the sensor 14 that detects the opening and closing of the door may be mounted on the circuit board 15. In addition, the circuit board 15 may be integrated with a control apparatus of the money handling apparatus 10 that comprehensively controls the entire money handling apparatus 10, including the conveyor 13. In other words, the control apparatus of the money handling apparatus 10 may also serve as the circuit board 15.

The circuit board 15 transmits information based on the detection signal acquired from the sensor 14 to the first computer 21. The information transmitted from the circuit board 15 may be the detection signal itself (for example, voltage value) acquired from the sensor 14, or information generated by the circuit board 15 processing the detection signal acquired from the sensor 14. The information generated by processing the detection signal may be a numerical value indicating a physical quantity detected by the sensor 14 (for example, the magnitude of vibration or temperature), or a further processed numerical value (for example, a moving average).

The first computer 21 is a computer used and managed by operators (for example, financial institutions such as banks, retail stores such as convenience stores, or security transport agencies, etc.) who operate the money handling apparatus 10. The first computer 21 monitors the state of the safe 12 based on the information acquired from the sensor 14 via the circuit board 15. The operators can know whether an event threatening the safety of the money stored in the safe 12 has occurred by monitoring the state of the safe 12 using the first computer 21.

The circuit board 15 transmits at least part of the information based on the detection signal acquired from the sensor 14 to the second computer 22. All information transmitted from the circuit board 15 to the first computer 21 may also be transmitted from the circuit board 15 to the second computer 22.

When the money handling apparatus 10 comprises a plurality of sensors 14, the circuit board 15 may transmit information based on detection signals acquired from part of the plurality of sensors 14 to the second computer 22. Whether or not to transmit information based on a detection signal acquired from each of the sensors 14 to the second computer 22 may be predetermined in software executed by the circuit board 15. In addition, when a new sensor 14 is added to the money handling apparatus 10, whether or not to transmit information based on a detection signal acquired from the added sensor 14 to the second computer 22 may be set in the software executed by the circuit board 15. The settings of the software executed by the circuit board 15 may be performed by the second computer 22.

In addition, the circuit board 15 may transmit to the second computer 22 only information based on a detection signal acquired during a certain period of time among pieces of information based on detection signals acquired from a single sensor 14.

The second computer 22 is a computer used and managed by maintenance operators, for example, who perform maintenance on the money handling apparatus 10. The second computer 22 monitors the state of the sensor 14, that is, whether the sensor 14 is operating normally without any faults or other anomalies, based on the information acquired from the sensor 14 via the circuit board 15. The second computer 22 monitors the state of the safe 12, and hence, the money handling apparatus 10, based on information acquired from the sensor 14 via the circuit board 15. The maintenance operators may be the manufacturers of the money handling apparatus, contractors entrusted with maintenance by the manufacturers or operators, or members (for example, employees) of the operators.

According to the money handling apparatus 10 and the money handling system 1 configured as described above, when a fault or other anomaly occurs in the sensor 14, an anomalous signal is transmitted from the sensor 14 to the circuit board 15, or a normal signal is not received. Then, the information indicating the anomaly is transmitted from the circuit board 15 to the second computer 22, or normal information is not received. In other words, the second computer 22 can detect the occurrence of a fault or other anomaly in the sensor 14. Therefore, the maintenance operator can detect anomalies that occur in the sensor 14, which detects the state of the safe 12 that the money handling apparatus 10 comprises. It should be noted that the determination of anomalies occurring in the sensor 14 may be made by the circuit board 15 or by the second computer 22. Abnormalities in a part of the sensors 14 may be detected by the circuit board 15, while anomalies in another part of the sensors 14 may be detected by the second computer 22.

The circuit board 15 may transmit information to the first computer 21 while simultaneously transmitting at least part of the information to the second computer 22. In this case, the second computer 22 can monitor the state of the sensor 14 in real-time. Therefore, the user of the second computer 22 can quickly notice any anomalies in the sensor 14 and perform maintenance, such as repairs, promptly.

It should be noted that the circuit board 15 may temporarily hold the information to be transmitted to the second computer 22 by storing it in a storage apparatus mounted on the circuit board 15. In this case, when a communication session between the second computer 22 and the money handling apparatus 10 is established, the held information may be transmitted to the second computer 22. The maintenance operator of the money handling apparatus 10 can check a previous operating state of the sensor 14 by connecting the second computer 22 to the money handling apparatus 10 via wired or wireless connection at an installation site of the money handling apparatus 10. In other words, even when the second computer 22 is not connected to the money handling apparatus 10 while it is handling money, the maintenance operator can quickly discover whether there are any anomalies such as malfunctions in the sensor 14 at the time of maintenance.

In addition, when the second computer 22 determines that an anomaly has occurred in the sensor 14, and hence in the money handling apparatus 10, based on the information received from the circuit board 15, it may transmit notification information to the first computer 21, indicating that the anomaly has occurred in the money handling apparatus 10. In this case, even when information does not reach the first computer 21 from the circuit board 15 due to network trouble or some other reason, the first computer can obtain information indicating that an anomaly has occurred in the sensor 14, and hence in the money handling apparatus 10. Therefore, the user of the first computer 21 can reliably respond to anomalies in the money handling apparatus 10.

### Embodiment 2

FIG. 2 is a block diagram of the money handling apparatus 10 and the money handling system 1 according to Embodiment 2 of the present disclosure. Hereinafter, descriptions of matters shared with Embodiment 1 may be omitted.

In the present embodiment, the circuit board 15 is disposed inside the safe 12. Therefore, only those who can unlock the door of the safe 12 can access the circuit board 15. Thus, it is possible to prevent the circuit board 15 from being altered by anyone other than those who can unlock the door. Consequently, it is possible to prevent a situation where the detection signals from the sensor 14 are no longer transmitted to the first computer 21 or the second computer 22.

### Embodiment 3

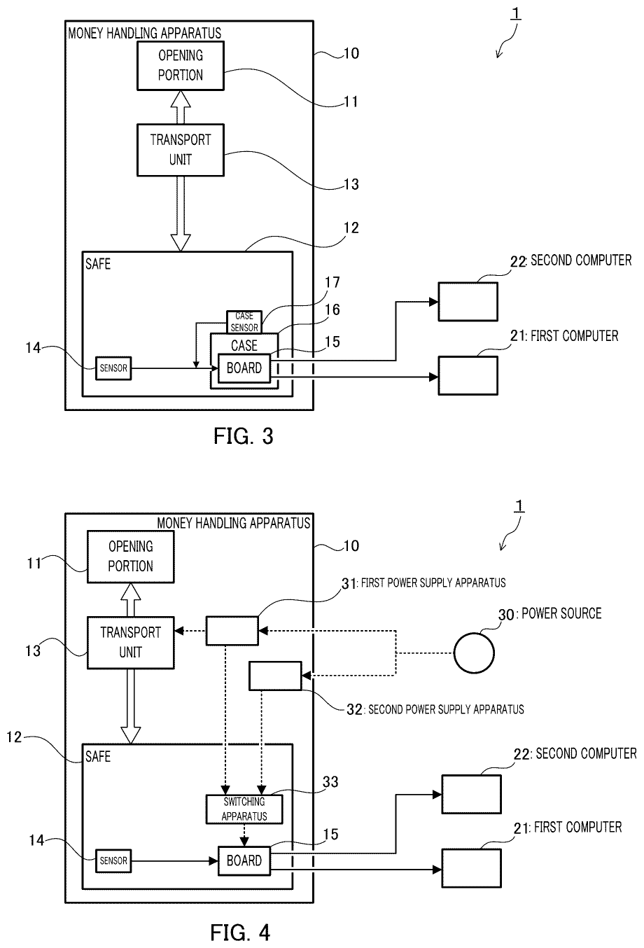

FIG. 3 is a block diagram of the money handling apparatus 10 and the money handling system 1 according to Embodiment 3 of the present disclosure. Descriptions of matters shared with the aforementioned embodiments may be omitted.

In the present embodiment, the money handling apparatus 10 comprises a case 16 that stores the circuit board 15 in a covered state. The case 16 is stored inside the safe 12. In other words, the circuit board 15 is stored inside the safe 12, and further, inside the case 16. Therefore, it is possible to more reliably prevent the circuit board 15 from being altered by anyone other than the operator or maintenance operator of the money handling apparatus 10. Consequently, it is possible to more reliably prevent the situation where the detection signal from the sensor 14 is not transmitted to either the first computer 21 or the second computer 22.

In addition, in the present embodiment, the money handling apparatus 10 comprises a case sensor 17 that detects the opening and closing state of the case 16. The case sensor 17 transmits a detection signal regarding the opening and closing state of the case 16 to the circuit board 15. When the circuit board 15 receives the detection signal from the case sensor 17, it transmits the detection signal regarding the opening and closing state of the case to at least one of the first computer 21 and the second computer 22. Therefore, when the case 16 is opened for any reason, the user of the first computer 21 or the second computer 22 can know that the case 16 has been opened. Consequently, it is possible to know that some alteration may have been made to the circuit board 15. Therefore, the operator of the money handling apparatus 10 can stop the money handling apparatus 10 in an emergency. In addition, the maintenance operator of the money handling apparatus 10 can perform emergency maintenance on the money handling apparatus 10.

Also, when the circuit board 15 receives a detection signal from the case sensor 17, it may transmit, to the control apparatus that the money handling apparatus 10 comprises, a signal indicating that the detection signal has been received. Then, upon receiving this signal, the control apparatus may automatically transition the money handling apparatus 10 into a state where it cannot dispense money.

### Embodiment 4

FIG. 4 is a block diagram of the money handling apparatus 10 and the money handling system 1 according to Embodiment 4 of the present disclosure. Hereinafter, descriptions of matters shared with the aforementioned embodiments may be omitted.

The money handling apparatus 10 according to the present embodiment operates with power supplied from a power source 30 (for example, a commercial power source). The money handling apparatus 10 comprises a first power supply apparatus 31, a second power supply apparatus 32, and a switching apparatus 33. The dashed arrows in FIG. 4 indicate the flow of electricity.

The first power supply apparatus 31 is configured to receive power from the power source 30 and to supply power to the conveyor 13 and the circuit board 15. The first power supply apparatus 31 may be a main power supply apparatus that supplies power to the entire money handling apparatus 10.

The second power supply apparatus 32 is configured to receive power from the power source 30 and to supply power to the switching apparatus 33. The second power supply apparatus 32 is configured so that it cannot supply power to the conveyor 13. The second power supply apparatus 32 may be a backup or auxiliary power supply apparatus that supplies power only to apparatuses necessary to maintain the safety of the money stored inside the safe 12.

The second power supply apparatus 32 receives power from the power source 30 through a power supply line different from that to the first power supply apparatus 31. For example, a power cable connected to the second power supply apparatus 32 is different from a power cable connected to the first power supply apparatus 31. Therefore, even when a plug is pulled out or the power cable is cut, and no power is supplied to the first power supply apparatus 31, the second power supply apparatus 32 can receive power supply from the power source 30.

The switching apparatus 33 is configured to supply power from the first power supply apparatus 31 to the circuit board 15 when power is supplied from the first power supply apparatus 31. Additionally, the switching apparatus 33 is configured to supply power from the second power supply apparatus 32 to the circuit board 15 when no power is supplied from the first power supply apparatus 31. In other words, the switching apparatus 33 is configured to automatically switch the flow of power to supply power from the second power supply apparatus 32 to the circuit board 15 when the supply of power from the first power supply apparatus 31 is interrupted.

It should be noted that the switching apparatus 33 may be mounted on the circuit board 15. In other words, the switching apparatus 33 may be integrated with the circuit board 15.

The money handling apparatus 10 according to the present embodiment operates with the power supplied through the first power supply apparatus 31 under normal conditions. That is, under normal conditions, power is supplied to the sensor 14 and the circuit board 15 through the first power supply apparatus 31 and the switching apparatus 33. Therefore, the sensor 14 and the circuit board 15 can operate normally.

In addition, when for some reason no power is supplied to the first power supply apparatus 31, the switching apparatus 33 will operate automatically. As a result, power is supplied to the sensor 14 and the circuit board 15 through the second power supply apparatus 32 and the switching apparatus 33. Therefore, even in such a situation, the sensor 14 and the circuit board 15 can operate normally.

Thus, according to the money handling apparatus 10 and the money handling system 1 of the present embodiment, even when the supply of power necessary for handling money is interrupted, the sensor 14 and the circuit board 15 can operate normally. In other words, the circuit board 15 can reliably acquire detection signals from the sensor 14, transmit information based on the acquired detection signals to the first computer 21, and transmit at least part of this information to the second computer 22.

### Embodiment 5

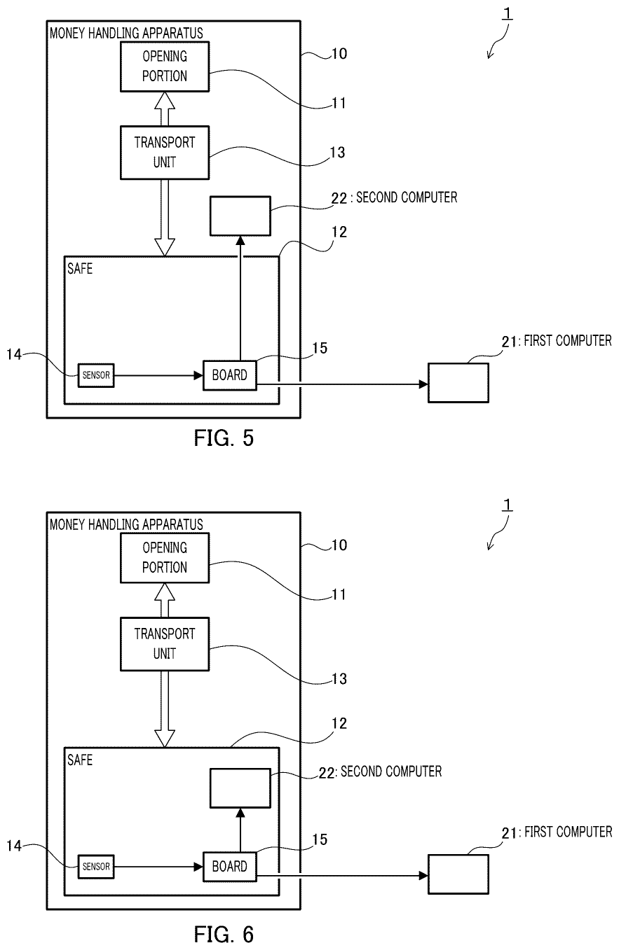

FIG. 5 is a block diagram of the money handling apparatus 10 and the money handling system 1 according to Embodiment 5 of the present disclosure. Hereinafter, descriptions of matters shared with the aforementioned embodiments may be omitted.

In the present embodiment, the money handling apparatus 10 comprises a second computer 22. The second computer 22 is disposed inside the money handling apparatus 10 and outside the safe 12. The second computer 22 may be comprised of a control apparatus of the money handling apparatus 10 that comprehensively control the entire money handling apparatus 10, including the conveyor 13.

The second computer 22 is connected to a maintenance computer, which is used by maintenance operators and is disposed outside the money handling apparatus 10, via wired or wireless communication. In cases where connection is made via wired communication, the maintenance computer may be connected to the second computer 22 only when maintenance is being performed, and at other times, it is not necessary for the maintenance computer to be connected to the second computer 22.

The second computer 22 may be configured to transmit information received from the circuit board 15 to the maintenance computer in real-time. In addition, the second computer 22 may be configured to store information received from the circuit board 15 in a storage apparatus that the second computer 22 comprises. In this case, the second computer 22 may transmit the stored information to the maintenance computer at a predetermined timing or in response to a request from the maintenance computer.

According to the money handling apparatus 10 and the money handling system 1 configured as described above, when a fault or other anomaly occurs in the sensor 14, an anomalous signal is transmitted from the sensor 14 to the circuit board 15, or a normal signal is not received. Then, information indicating an anomaly is transmitted from the circuit board 15 to the second computer 22, or normal information is not received. That is, the second computer 22 can detect that a fault or other anomaly has occurred in the sensor 14. And, the second computer 22 can transmit information indicating that a fault or other anomaly has occurred in the sensor 14 to the maintenance computer. Therefore, the maintenance operator can discover the anomaly that have occurred in the sensor 14, which detects the state of the safe 12 that the money handling apparatus 10 comprises.

Additionally, the second computer 22 may transmit the received information to the maintenance computer simultaneously with receiving it. In addition, the second computer 22 may temporarily hold the information to be transmitted to the maintenance computer by storing it in a storage apparatus mounted in the second computer 22. In this case, the held information may be transmitted to the maintenance computer when a communication session between the maintenance operator and the second computer 22 is established.

### Embodiment 6

FIG. 6 is a block diagram of the money handling apparatus 10 and the money handling system 1 according to Embodiment 6 of the present disclosure. The present embodiment differs from Embodiment 5 in that the second computer 22 is disposed inside the safe 12.

In the present embodiment, the second computer 22 is disposed inside the safe 12. Therefore, only those who can unlock the door of the safe 12 can access the second computer 22. Thus, it is possible to prevent the second computer 22 from being altered by anyone other than those who can unlock the door.

### Embodiment 7

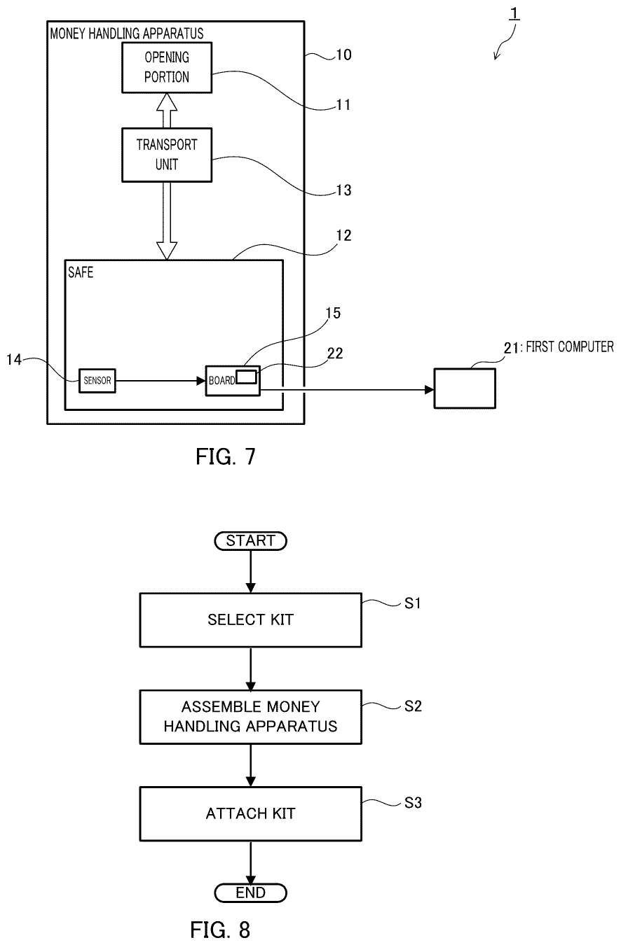

FIG. 7 is a block diagram of the money handling apparatus 10 and the money handling system 1 according to Embodiment 6 of the present disclosure. The present embodiment differs from Embodiment 6 in that the second computer 22 is mounted on the circuit board 15.

In the present embodiment, the second computer 22 is disposed inside the safe 12 and is mounted on the circuit board 15. In other words, the second computer 22 is integrated with the circuit board 15. Therefore, no one except the person who can unlock the door of the safe 12 can touch the second computer 22. Thus, it is possible to prevent the second computer 22 from being altered by anyone other than the person who can unlock the door. In addition, by integrating the second computer 22 with the circuit board 15, it is possible to eliminate the need for wiring between the circuit board 15 and the second computer 22. Additionally, it is possible to reduce the number of components by one. In other words, it is possible to simplify the configuration of the money handling apparatus 10.

Note that the second computer 22 does not have to be mounted on the circuit board 15 and may be disposed adjacent to the circuit board 15 inside the safe 12. In such an arrangement, it is possible to substantially integrate the second computer 22 with the circuit board 15, minimizing the necessary wiring between the circuit board 15 and the second computer 22.

### (Manufacturing Method for Manufacturing the Money Handling Apparatus)

Next, the manufacturing method for manufacturing the money handling apparatus 10 according to the present disclosure will be described.

To begin with, a kit to be attached to the money handling apparatus 10 is selected (S1). The kit to be attached is one kit selected from a group of kits that includes a plurality of kits. Table 1 shows an example of a group of kits.

Table 1 shows an example of a group of kits.

TABLE 1

| Kit No. | Kit Configuration |
|---|---|
| 1 | Circuit board, temperature sensor (1) |
| 2 | Circuit board, door opening/closing sensor (1) |
| 3 | Circuit board, vibration sensor (1) |
| 4 | Circuit board, temperature sensor (2) |
| 5 | Circuit board, temperature sensor (1), door opening/closing |
| | sensor (1) |
| 6 | Circuit board, temperature sensor (2), door opening/closing |
| | sensor (1) |
| . | . |
| . | . |
| . | . |

Each of the plurality of kits included in the group of kits contains one circuit board 15 and at least one sensor 14. The plurality of kits respectively include sensors 14 that differ from one another among the kits, and circuit boards 15 of a type that is common to the kits.

That is, the circuit boards 15 included in the kits are the same as each other. Also, the sensors 14 included in the kits are different from each other. In other words, the type and number of sensors 14 included in one kit differ from the combination of type and number of sensors 14 included in another kit. For example, one kit may include only one sensor as the sensor 14, which detects the temperature of the safe 12. Another kit may include only two sensors as the sensors 14, which detect the temperature of the safe 12. In addition, another kit may include one sensor as the sensor 14 that detects the temperature of the safe 12 and one sensor that detects the opening and closing of the door of the safe 12.

The selection of the kit is based on the needs of the operator of the money handling apparatus 10 to be manufactured.

Next, the money handling apparatus 10 is assembled (S2).

Subsequently, the selected kit is attached to the money handling apparatus 10 (S3), completing the money handling apparatus 10. Note that the attachment of the kit may be carried out in parallel with the assembly of the money handling apparatus 10. Also, the selection of the kit may be made after the money handling apparatus 10 has been assembled (i.e., S1 may be performed after S2).

The manufacturing of the money handling apparatus 10 may be performed manually by an assembler or may be automated or semi-automated using Factory Automation (FA), that is, by a manufacturing apparatus. When FA is used, the manufacturing apparatus may be comprised of one or more robots controlled by one or more computers. One or more robots controlled by one or more computers execute at least part of the procedures S1, S2, and S3. Known techniques can, for example, be employed for FA as well as the computers and robots constituting FA.

According to the manufacturing method, it is possible to produce the money handling apparatus 10 equipped with the sensor 14 that meets the needs of the operator of the money handling apparatus 10.

In addition, when a plurality of money handling apparatuses 10 are manufactured using the above manufacturing method, the type of circuit board 15 is common to the money handling apparatuses 10, regardless of the type and number of sensors 14 attached. Therefore, it is possible to manufacture a plurality of types of money handling apparatuses 10 comprising various sensors 14 while limiting the type of circuit board 15 to a single type. Also, when the circuit board 15 is improved (for example, the software executed by the circuit board 15 is updated) after the start of operation of the money handling apparatus 10, the work for a plurality of money handling apparatuses 10 can be the same.

In addition, the structure of the money handling apparatus 10 can be optimized for the sensor 14 included in the kit. For example, there is no need to consider that sensors are added afterwards by the operator of the money handling apparatus 10 after it is shipped, or that the type and number of sensors to be attached are determined after the design of the money handling apparatus 10 is completed. Therefore, there is no need to provide the money handling apparatus 10 with unnecessary margins to accommodate various conditions. In other words, the money handling apparatus 10 can be made compact.

It should be noted that the present disclosure is not limited to the embodiments specifically described so far, but also includes various modifications made within the spirit of the disclosure. For example, combinations of specific configurations of each embodiment selected at will are also included in the present disclosure. For instance, the circuit board 15 with the second computer 22 implemented as shown in FIG. 7 may be housed in the case 16 as shown in FIG. 5. In this case, it is possible to reliably prevent alteration to the second computer 22 in addition to alteration to the circuit board 15. Also, power may be supplied to the circuit board 15 housed in the case 16 from the first power supply apparatus 31 or the second power supply apparatus 32 through the switching apparatus 33 as shown in FIG. 4.

In addition, by applying the technical idea of the present disclosure, it is possible to detect anomalies in sensors that detect the state of safes storing money. In this case, the safe comprises a door that is openable/closable and lockable. Inside this safe, there may be a storage box for storing money. The storage box is pulled out of the safe through the opening of the safe when the door is opened. The storage box may be disposed on a slider. By disposing the storage box on the slider, the storage box can be easily pulled out of the safe.

In addition, an inlet is formed in one side of this safe. This inlet is connected to the storage box via a chute. In other words, money inserted into the safe through the inlet slides down the chute and enters the storage box. It should be noted that money enclosed in envelopes may also be inserted into the safe through the inlet.

Inside this safe, for example, inside the storage box, a sensor is installed. The sensor detects at least one of the following: the opening and closing of the safe door, the vibration of the safe, the temperature of the safe, and the condition of the fixing member that secures the safe to a fixation portion.

Also, inside this safe, for example, inside the storage box, a circuit board is disposed. The circuit board acquires a detection signal from the sensor. Since the configuration and function of the circuit board are the same as those of the circuit board 15 according to the above-described embodiments, detailed description thereof is omitted.

Since the safe configured as described above comprises the sensor and the circuit board, the safe can exhibit the same effects as the money handling apparatus 10 according to the above-described embodiments. That is, when a failure or other anomaly occurs in the sensor, the second computer, which receives at least part of the information based on the detection signal acquired from the sensor, can detect that the failure or other anomaly has occurred in the sensor. Therefore, the maintenance operator can discover any anomalies that occur in the sensors detecting the state of the safe.

1. A money handling apparatus, comprising:
a safe for storing money;
a conveyor that performs at least one of transporting the money to the safe and transporting the money from the safe;
at least one sensor that detects a state of the safe; and
a circuit board that acquires a detection signal from the sensor, transmits information based on the acquired detection signal to a first computer, and transmits at least part of the information to a second computer.

2. The money handling apparatus according to claim 1, wherein
the circuit board is disposed inside the safe.

3. The money handling apparatus according to claim 1, further comprising:
a case that houses the circuit board in a covered state.

4. The money handling apparatus according to claim 3, further comprising:
a case sensor that transmits a detection signal regarding an opening and closing state of the case to the circuit board, wherein
the circuit board transmits the detection signal regarding the opening and closing state to at least one of the first computer and the second computer upon acquiring the detection signal regarding the opening and closing state.

5. The money handling apparatus according to claim 1, further comprising:
a first power supply apparatus configured to be capable of supplying power to the conveyor and the circuit board, and
a second power supply apparatus configured to be incapable of supplying power to the conveyor but capable of supplying power to the circuit board, and
a switching apparatus that, when supplied with power from the first power supply apparatus, supplies the power supplied from the first power supply apparatus to the circuit board, and when not supplied with power from the first power supply apparatus, supplies the power supplied from the second power supply apparatus to the circuit board.

6. The money handling apparatus according to claim 1, wherein
the sensor is a sensor that detects at least one of opening and closing of a door of the safe, a vibration of the safe, a temperature of the safe, and a condition of a fixing member that fixes the money handling apparatus to a fixation portion.

7. A money handling system, comprising:
a money handling apparatus connected to a first computer; and
a second computer connected to the money handling apparatus, wherein
the money handling apparatus comprises:
a safe for storing money;
a conveyor that performs at least one of transporting the money to the safe and transporting the money from the safe;
at least one sensor that detects a state of the safe; and
a circuit board that acquires a detection signal from the sensor, transmits information based on the acquired detection signal to the first computer, and transmits at least part of the information to the second computer, and
the second computer monitors the money handling apparatus based on the at least part of the information.

8. The money handling system according to claim 7, wherein
the second computer is disposed inside the money handling apparatus.

9. The money handling system according to claim 8, wherein
the second computer is disposed inside the safe.

10. The money handling system according to claim 9, wherein:
the circuit board is disposed inside the safe, and
the second computer is either disposed adjacent to the circuit board or integrated with the circuit board.

11. The money handling system according to claim 7, wherein
the second computer is disposed outside the money handling apparatus and is communicably connected to the money handling apparatus.

12. The money handling system according to claim 7, wherein
the circuit board transmits the information to the first computer and simultaneously transmits the at least part of the information to the second computer.

13. The money handling system according to claim 11, wherein
the circuit board temporarily holds the at least part of the information, and transmits the at least part of the information to the second computer in case that a communication session between the second computer and the money handling apparatus is established.

14. The money handling system according to claim 7, wherein
the first computer monitors the money handling apparatus based on the information.

15. The money handling system according to claim 14, wherein
in case that the second computer determines, based on the at least part of the information, that an anomaly occurs in the money handling apparatus, the second computer transmits, to the first computer, notification information indicating the occurrence of the anomaly in the money handling apparatus.

16. A manufacturing method for manufacturing a money handling apparatus, comprising:
selecting one kit from a group of kits that include a plurality of kits with configurations different from one another;
assembling a money handling apparatus that comprises a safe and a conveyor that performs at least one of transporting money to the safe and transporting the money from the safe; and
attaching the selected kit to the money handling apparatus, wherein
each kit of the plurality of kits includes a sensor that differs from one another among the plurality of kits and a circuit board of a type that is common to the plurality of kits.
